(19) United States
(12) Patent Application Publication
(10) Pub. No.: US 2019/0230401 A1
(43) Pub. Date: Jul. 25, 2019

(54) COORDINATING MEDIA CONTENT FOR PRESENTATION AT A VEHICLE

(71) Applicant: GM GLOBAL TECHNOLOGY OPERATIONS LLC, Detroit, MI (US)

(72) Inventors: Spencer W. Chamberlain, Sterling Heights, MI (US); Zafar Razzacki, Canton, MI (US); John McDougall, Detroit, MI (US); Miranda P. Steinhauser, Royal Oak, MI (US)

(21) Appl. No.: 15/875,649

(22) Filed: Jan. 19, 2018

(51) Int. Cl. H04N 21/414; H04N 21/41; H04N 21/466; G06Q 30/02; H04L 29/08

(52) U.S. Cl. CPC H04N 21/41422; H04N 21/4126; H04L 67/12; G06Q 30/0265; H04N 21/4668

(57) ABSTRACT

A system and method of managing media content for coordinated content playback at a vehicle, the method including: receiving a vehicle playback indication, wherein the vehicle playback indication indicates that media content is or recently was being presented on a personal content playback device; receiving media content playback information concerning playback of the media content to be carried out at the vehicle and/or playback of the media content at the personal content playback device; obtaining media content based on the media content playback information; and sending the media content to the vehicle, wherein the vehicle is configured to present the media content at the vehicle using one or more vehicle-user interfaces that are installed in the vehicle.

### INTRODUCTION

The present invention relates to coordinating media content playback between a vehicle and a personal content playback device.

Vehicles include hardware and software capable of various multimedia functions, including playing audio received from radio stations, mobile devices (e.g., smartphones, tablets), many of which utilize wireless communications, such as short-range wireless communications (SRWC). Additionally, vehicles include numerous vehicle user interfaces that can be used to present information and media content to an operator or a passenger of the vehicle. Other electronic devices can include network capabilities and audiovisual output interfaces so that media content can be streamed or downloaded, as well as presented to the user using the audiovisual output interfaces.

### SUMMARY

According to one aspect of the invention, there is provided a method of managing media content for coordinated content playback at a vehicle, the method including: receiving a vehicle playback indication, wherein the vehicle playback indication indicates that media content is or recently was being presented on a personal content playback device; receiving media content playback information concerning playback of the media content to be carried out at the vehicle and/or playback of the media content at the personal content playback device; obtaining media content based on the media content playback information; and sending the media content to the vehicle, wherein the vehicle is configured to present the media content at the vehicle using one or more vehicle-user interfaces that are installed in the vehicle.

According to various embodiments, this method may further include any one of the following features or any technically-feasible combination of these features:
the vehicle playback indication further includes receiving an indication that a vehicle reservation is to begin, wherein the vehicle reservation is a reservation for the user to use or ride along in the vehicle;
sending a media content request to a third party content provider and, in response to the media content request, obtaining the media content;
the media content playback information includes a third party content provider identifier that identifies a third party content provider that is or recently was providing the media content to the personal content playback device;
the third party content provider credentials are used to query a database for third party content provider credentials, and wherein the media content request includes the third party content provider credentials;
sending a first media content request from a vehicle backend services facility to a vehicle media content engine, wherein the first media content request includes at least some of the media content playback information;
processing the media content using the vehicle media content engine based on vehicle-user interface information concerning one or more vehicle-user interfaces at the vehicle that are configured to provide audio and/or visual output and, thereafter, sending the processed media content to the vehicle;
sending a second media content request to a third party content provider, wherein the second media content request is at least partly based on information received in the first media content request;
the second media content request includes or is accompanied by vehicle addressing and/or identification information, wherein the media content is sent from the vehicle media content engine to the vehicle based at least partly on the vehicle addressing and/or identification information; and/or
the personal content playback device is a smartphone, smart television, laptop, tablet, or personal computer.

According to another aspect of the invention, there is provided a method of managing media content for coordinated content playback at a vehicle, the method including: receiving an indication of a vehicle reservation at a vehicle backend services facility, wherein the vehicle reservation includes a reservation start time and a reservation start location; receiving media content playback information from a personal content playback device of a user; sending a first media content request to a vehicle media content engine, wherein the first media content request includes vehicle addressing and/or identification information, wherein the media content is sent to the vehicle based at least partly on the vehicle addressing and/or identification information; and sending a second media content request to a third party content provider, wherein the second media content request includes at least some of the information contained in the first media content request.

According to various embodiments, this method may further include any one of the following features or any technically-feasible combination of these features:
receiving the media content from the third party content provider in response to the second media content request and sending the received media content to the vehicle based on the vehicle addressing and/or identification information;
processing the received media content before sending the received media content to the vehicle, wherein the processing includes configuring the media content for playback at one or more vehicle-user interfaces included in the vehicle, and wherein the processing is based on vehicle-user interface information concerning one or more vehicle-user interfaces at the vehicle that are configured to provide audio and/or visual output;
the media content is processed based on a selected immersive media experience, and wherein the selected immersive media experience includes media content playback preferences;
wherein at least some of the media content playback preferences of the selected immersive media experience are selected or set by the user of the personal content playback device;
wherein the second media content request includes the vehicle addressing and/or identification information such that the media content can be directly delivered from the third party content provider to the vehicle; and/or
the vehicle is configured to receive the media content and to present the media content using one or more vehicle-user interfaces included in the vehicle.

According to another aspect of the invention, there is provided a vehicle backend system, including: a vehicle backend services facility that includes a plurality of vehicle backend services servers and a plurality of vehicle backend services databases, wherein at least some of the plurality of vehicle backend services servers includes a processing device that is configured to execute a vehicle backend services computer program; a vehicle media content engine that includes a plurality of vehicle media content engine servers and a plurality of vehicle media content engine databases, wherein at least some of the plurality of vehicle media content engine servers includes a processing device that is configured to execute a vehicle media content engine computer program; wherein the processing devices of the at least some vehicle backend services servers, when executing the vehicle backend services computer program, causes the vehicle backend services system to: receive an indication of a vehicle reservation at the vehicle backend services facility, wherein the vehicle reservation includes a reservation start time and a reservation start location; receive media content playback information from a personal content playback device of a user; send a first media content request to the vehicle media content engine, wherein the first media content request includes vehicle addressing and/or identification information, wherein the media content is sent to the vehicle based at least partly on the vehicle addressing and/or identification information; and wherein the processing devices of the at least some vehicle media content engine servers, when executing the vehicle media content engine computer program, causes the vehicle backend services system to: receive the first media content request from the vehicle backend services facility; and send a second media content request to a third party content provider, wherein the second media content request includes at least some of the information contained in the first media content request.

According to various embodiments, this system may further include any one of the following features or any technically-feasible combination of these features:
the processing devices of the at least some vehicle media content engine servers, when executing the vehicle media content engine computer program, further causes the vehicle backend services system to receive the media content from the third party content provider and to send the media content to the vehicle; and/or
the processing devices of the at least some vehicle media content engine servers, when executing the vehicle media content engine computer program, further causes the vehicle backend services system to process the received media content before sending the media content to the vehicle.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of an embodiment of a method of managing media content for coordinated content playback at a vehicle; and

FIG. 3 is flowchart of another embodiment of a method of managing media content for coordinated content playback at a vehicle.

### DETAILED DESCRIPTION

The system and method described below enables the coordination and/or management of media content playback between a personal device and a vehicle, including managing media content being presented at the personal content playback device so that the presentation of the media content can be continued at the vehicle. For example, a user may access media content from a third party media content provider using a personal content playback device, such as a smart television (smart TV), a smartphone, a tablet, a personal computer (PC), or other electronic computing device that includes network capabilities that enable streaming media content playback and/or downloading of media content for playback. In one scenario, a user may watch a movie on their smartphone using a third party streaming media content provider (e.g., Netflix™) and, upon the user arriving at a vehicle, the media content (e.g., the movie) can be paused on the smartphone and continued at the vehicle using one or more vehicle-user interfaces, such as a display screen, projection screen, and/or audio system.

According to many embodiments, the system and method can use a vehicle backend services server (or servers) along with a vehicle media content engine to receive content playback information (e.g., the media content source, the media content title, media content playback properties including playback position) and to access and process media content from third party content providers. In one embodiment, the method can include the steps of receiving content playback information concerning media content that is being presented to the user on a personal content playback device (e.g., smartphone) of the user, obtaining and processing the media content so that the media content can be presented at the vehicle using one or more vehicle-user interfaces, and sending the processed media content to the vehicle for presentation using the vehicle-user interfaces.

At least in some embodiments, the vehicle backend services, which is described in more detail below, can be used to manage vehicle reservations as well as provide backend services to the vehicle and/or the personal content playback device. The vehicle media content engine, which is also described in more detail below, can be used to obtain media content from one or more third party content providers (e.g., Netflix™, Hulu™ YouTube™) and to process the obtained media content for playback at the vehicle using one or more vehicle-user interfaces. The playback devices used by the vehicle may differ from those of the personal content playback device (e.g., smartphone, smart TV) and, thus, the vehicle media content engine may process the media content so that the media content is formatted properly or transformed for playback using the vehicle-user interfaces. In one scenario, a user may access three-dimensional media content for playback at a virtual reality (VR) device (i.e., a personal content playback device with VR capabilities) that renders three-dimensional graphics. The user may desire to continue playback of the media content at the vehicle, but the vehicle may not include three-dimensional playback devices and, thus, the media content can be processed by the vehicle media content engine to obtain two-dimensional media content that can be presented using the vehicle-user interfaces. In another embodiment, the two-dimensional media content can be requested by the vehicle media content engine from the third party content provider and then provided to the vehicle for playback.

And, according to some embodiments, the vehicle media content engine and/or vehicle backend services server can include various user information pertaining to third party content providers, such as subscription information and credentials. The vehicle can obtain user credentials for a variety of content providers that enables the user to access media content offered by the various content providers. The credentials can be in the form of a username/password pair and/or can be in the form of a token that carries entitlements and/or authorization to use certain services. For example, the vehicle media content engine may hold subscription information in a database and use the subscription information to access and obtain media content from the content providers, which can then be processed and sent to the vehicle. In one embodiment, the subscription information held at the vehicle media content engine can be third party content provider credentials and, thus, these credentials can be used to authorize reception of media content from the respective third party content provider. In another embodiment, the subscription information held at the vehicle media content engine can be a token that indicates a user that presents the token is authorized to access media content from a particular third party content provider. In this embodiment, the vehicle or vehicle media content engine can then use its own subscription or credentials to access media content from the third party content provider.

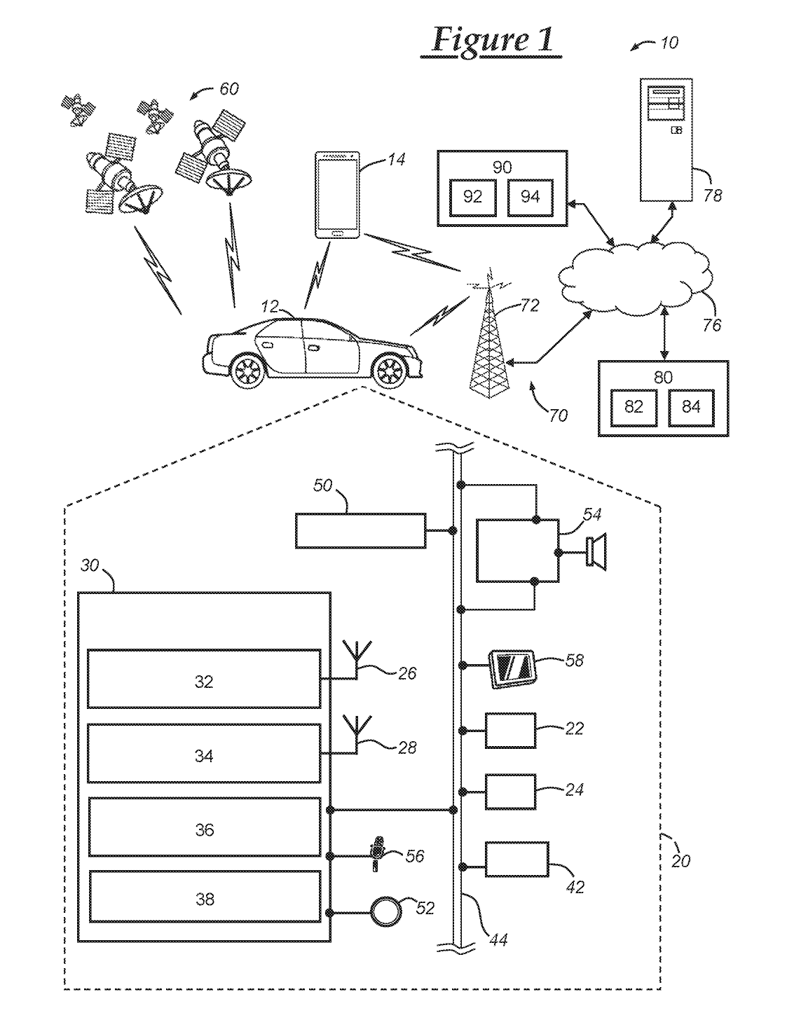

With reference to FIG. 1, there is shown an operating environment that comprises a communications system 10 and that can be used to implement the method disclosed herein. Communications system 10 generally includes a vehicle 12 with a wireless communications device 30, a personal content playback device 14, a constellation of global navigation satellite system (GNSS) satellites 60, one or more wireless carrier systems 70, a land communications network 76, a computer or server 78, a vehicle backend services facility 80, and a vehicle media content engine 90. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicles 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to remote facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof

Computers 78 (only one shown) can be some of a number of computers accessible via a private or public network such as the Internet. Each such computer 78 can be used for one or more purposes, such as a third party content provider server. For example, computers 78 can be servers operated by third party content providers that are used to provide media content playback devices with media content for presentation to one or more users. The media content can be audio and/or visual entertainment content, including movies, television shows, music videos, other videos, songs, music, podcasts, live camera feeds (security web camera, infant video camera, entertainment web camera (such as a live video feed of a dance club)), etc. In one embodiment, the media content can be non-vehicle related media content, which is media content that is not related to and/or does not concern the vehicle. Third party content providers can be those that provide media content via a remote network connection, such as via the Internet, and such providers can include, for example, Netflix™, Hulu™, Amazon Prime™, FuboTV™, and Youtube™.

Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a car sharing server which coordinates registrations from a plurality of users who request to use a vehicle as part of a car sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12. In one embodiment, computers 78 can be used to carry out the method discussed herein; in other embodiments, the method can be carried out by servers or other computing devices at remote facility 80, as discussed more below; and, it yet another embodiment, the method can be carried out by a combination of computers 78 and servers at remote facility 80.

Remote facility 80 may be designed to provide the vehicle electronics 20 and personal content playback device 14 with a number of different system back-end functions through use of one or more electronic servers and, in such cases, can be referred to as a vehicle backend services facility. The remote facility 80 includes servers (vehicle backend services servers) 82 and databases 84, which may be stored on a plurality of memory devices. Also, remote facility 80 can include one or more switches, live advisors, an automated voice response system (VRS), all of which are known in the art. Remote facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

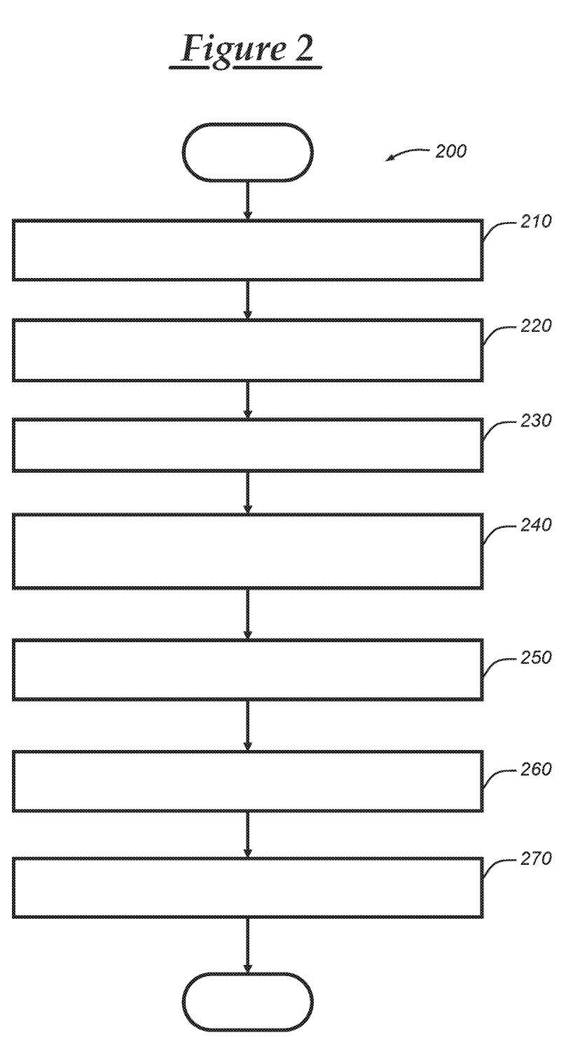

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware programs stored in the memory (e.g., EEPROM, RAM, ROM), which enable the servers 82 to provide a wide variety of services. For instance, the at least one processor can execute programs or process data to carry out at least a part of the method discussed herein. For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70. In one embodiment, servers 82 include an application that carries out at least some of the method illustrated below in FIG. 2.

Databases 84 can be stored on a plurality of memory, such as a powered memory or any non-transitory computer-readable medium; these include different types of RAM (random access memory), ROM (read only memory), and magnetic or optical disc drives that stores some or all of the software needed to carry out the various external device functions discussed herein. One or more databases at the remote facility can store account information such as vehicle services subscriber authentication information, vehicle identifiers, profile records, behavioral patterns, and other pertinent subscriber information. Also, a vehicle information database can be included that stores information pertaining to one or more vehicles.

Remote facility 90 can be a vehicle media content engine that can hold or obtain media content subscription information pertaining to one or more third party content providers and one or more users. The remote facility 90 can include similar hardware such as that which is described above with respect to remote facility 80. For example, servers 92 can include hardware and/or be configured in a manner similar to that of servers 82, although the respective servers may provide different functionality. And, similarly, databases 94 can include similar hardware and/or be configured in a manner similar to that of databases 84, although the organization or schema as well as the content of the databases may vary.

In one embodiment, vehicle media content engine 90 can include a plurality of third party content provider credentials that correspond to a user's account held with a third party content provider. For example, a first user may hold a subscription to Netflix™ and Hulu™, while a second user may hold a subscription to Hulu™ and Amazon Prime™. The database 94 can hold a username/password pair for Netflix™ that is associated with the first user and also can hold a username/password pair for Hulu™ that is associated with the first user. Additionally, the database 94 can hold old a username/password pair for Hulu™ that is associated with the second user, as well as a username/password pair for Amazon Prime™ that is associated with the second user. These credentials can be recalled from the database and used to obtain media content from third party content providers in response to receiving a media content request. Thereafter, through use of servers 92 (or electronic computing devices), the vehicle media content engine 90 can process the obtained media content and then send the processed media content to vehicle 12 for playback.

The personal content playback device 14 is a device that is capable of presenting media content to a user via one or more device-user interfaces. In some embodiments, the personal content playback device can be an electronic computing device that is configured to receive media content from a third party content provider and to present the received media content at one or more user-device interfaces. For example, the personal content playback device can be a smartphone, personal computer (PC), laptop, tablet, smart television, and/or a dongle (e.g., such as those that may be connected to a television including Chromecast™ and Firestick™). In many embodiments, the personal content playback device 14 can be a personal mobile device such as a smartphone and may include: hardware and software enabling cellular telecommunications and short-range wireless communications (SRWC) as well as other mobile device applications. For this purpose, it may include a processor and non-transitory computer readable memory storing the software for access and execution by the processor. As used herein, a personal mobile device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC and that includes the requisite SRWC circuitry to perform such SRWC.

In many embodiments, the hardware of personal content playback device 14 may comprise a processor and memory (e.g., non-transitory computer readable medium configured to operate with the processor) for storing the software, firmware, etc. The personal content playback device's processor and memory may enable various software applications, which may be preinstalled or installed by the user (or manufacturer) (e.g., having a software application or graphical user interface (GUI)). One implementation of a mobile device application may enable the personal content playback device 14 to receive media content via land network 76 and/or cellular carrier system 70 and to play or otherwise present the media content to a user via one or more user-device interfaces at the personal content playback device. In one embodiment, personal content playback device 14 may include a display that can be used to visually present media content to a user and may include an audio system that can be used to audibly present media content to a user.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) module 22, engine control unit (ECU) 24, a wireless communications device 30, other vehicle system modules (VSMs) 42, and numerous other components and devices. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS module 22, ECU 24, wireless communications device 30, and vehicle-user interfaces 52-58, as will be described in detail below. The vehicle 12 can also include other VSMs 42 in the form of electronic hardware components that are located throughout the vehicle and, which may receive input from one or more sensors and use the sensed input to perform diagnostic, monitoring, control, reporting, and/or other functions. Each of the VSMs 42 is preferably connected by communications bus 44 to the other VSMs, as well as to the wireless communications device 30, and can be programmed to run vehicle system and subsystem diagnostic tests. One or more VSMs 42 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Wireless communications device 30 is capable of communicating data via short-range wireless communications (SRWC) and/or via cellular network communications through use of a cellular chipset 34, as depicted in the illustrated embodiment. In the illustrated embodiment, wireless communications device 30 includes an SRWC circuit 32, a cellular chipset 34, a processor 36, memory 38, and antennas 26 and 28. In one embodiment, wireless communications device 30 may be a standalone module or, in other embodiments, device 30 may be incorporated or included as a part of one or more other vehicle system modules, such as a center stack module (CSM), a body control module (BCM), an infotainment module, a telematics unit, a head unit, and/or a gateway module. In some embodiments, the device 30 can be implemented as an OEM-installed (embedded) or aftermarket device that is installed in the vehicle.

Wireless communications device 30 can be configured to communicate wirelessly according to one or more wireless protocols, including short-range wireless communications (SRWC) such as any of the IEEE 802.11 protocols, Wi-Fi™, WiMAX™, ZigBee™, Wi-Fi direct™, Bluetooth™, Bluetooth™ Low Energy (BLE), or near field communication (NFC). As used herein, Bluetooth™refers to any of the Bluetooth™ technologies, such as Bluetooth Low Energy™(BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device. Additionally, in some embodiments, the wireless communications device may contain a cellular chipset 34 thereby allowing the device to communicate via one or more cellular protocols, such as those used by cellular carrier system 70. In other embodiments, the cellular chipset 34 may be incorporated into another VSM, such as a separate telematics unit.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. Memory 38 may be a powered memory or any non-transitory computer-readable medium; these include different types of RAM (random access memory) and ROM (read only memory) that stores some or all of the software needed to carry out the various external device functions discussed herein.

In one embodiment, the wireless communications device 30 may operate both when the vehicle is in a powered on state and when the vehicle is in a powered off state. As used herein, a “powered on state” is a state of the vehicle in which the ignition or primary propulsion system of the vehicle is powered on and, as used herein, a “powered off state” is a state of the vehicle in which the ignition or primary propulsion system of the vehicle is not powered on. The operation or state of the wireless communications device 30 may be controlled by another vehicle system module, such as by a body control module or by an infotainment module. In the powered on state, the wireless communications device 30 may always be kept “on” or supplied with power from a vehicle battery or other power source. In the powered off state, the wireless communications device 30 may be kept in a low-power mode or may be supplied power periodically so that device 30 may wake up and perform operations.

The vehicle may use the wireless communications device 30 to detect other SRWC devices, such as personal content playback devices 14. A connection between the wireless communications device 30 and one or more devices 14 may allow for the operation of various vehicle-device functionality. Vehicle-device functionality (or function) refers to any function of the vehicle that may be complimented, improved, supported, or carried out through a personal content playback device; any function of the personal content playback device that may be complimented, improved, supported, or carried out through the vehicle; or any other function that may be carried out using the vehicle and one or more personal content playback devices. For example, vehicle-device functionality can include using the personal content playback device 14 to provide the vehicle with a contact list that may be displayed on visual display 58, audio/visual media content to be played via speakers 54 or display 58, navigational information (e.g., start and/or end locations), and/or vehicle commands or instructions that direct the vehicle to perform some operation. Other examples of vehicle-device functionality include using the vehicle electronics to provide the personal content playback device with hands-free calling, such as through use of vehicle-user interfaces to place, receive, and carry out voice calls; sending information to the personal mobile device, such as geographical information to the personal content playback device 14 (such as information obtained from the GPS module 22) or vehicle diagnostic information or codes; and carrying out commands (e.g., commands to perform certain vehicle functions) received at the vehicle from the personal content playback device.

The wireless communications device 30 may be configured to listen for one or more wireless signals, such as those that may be sent by personal content playback device 14. In one embodiment, wireless communications device 30 may receive a message from a remote facility 80 that indicates a user will be soon arriving pursuant to a vehicle reservation that was made for the user. The device 30 may then listen for wireless signals from a personal content playback device or from a remote server, such as vehicle media content engine 90. In one embodiment, wireless communications device 30 may be set to a discovery mode when a user will be soon arriving to ride or otherwise use the vehicle. As used herein, a discovery mode is an operating mode for a SRWC device in which the SRWC device sends out wireless messages that typically are intended to discover or detect other SRWC devices using a SRWC protocol or technology. The discovery mode may include periodically or intermittently sending out messages or advertisements in an attempt to elicit a response from other SRWC devices in range. In one embodiment, the wireless communications device 30 may transmit a Bluetooth™ Low Energy advertising package (e.g., an advertisement), such as an ADV IND (an undirected advertisement) message, an ADV DIRECT IND (a directed advertisement) message, or an ADV SCAN IND (scan-able undirected advertisement). For example, the wireless communications device 30 may transmit an ADV IND message according to a predefined or predetermined time interval (e.g., 30 milliseconds (ms)). Or, the device 30 may vary the time interval by randomizing the interval (e.g., randomly or pseudo-randomly selecting a time between 10 ms and 40 ms for each advertisement).

In addition, once the vehicle receives a notification or otherwise realizes that a user will be soon arriving at the vehicle, the vehicle may power on or prepare one or more vehicle-user interfaces for media content playback. This preparatory step can be carried out according to default instructions or can be based on reservation information (including the identity of the user, the time of the reservation, personal reservation preferences) and/or content playback information. Content playback information can include a source of media content, title of media content, playback position of media content, volume of media content, closed captioning settings of media playback, language settings for media playback, and various other preferences and/or attributes of the media content playback. In some embodiments, the content playback information can be received directly from the personal media content playback device via SRWC. Or, in other embodiments, the content playback information can be received from the vehicle media content engine or vehicle backend services facility.

Global navigation satellite system (GNSS) module 22 receives radio signals from a constellation of GNSS satellites. In one embodiment, the GNSS module 22 may be a global positioning system (GPS) module, which may receive GPS signals from a constellation of GPS satellites 60. From these signals, the module 22 can determine vehicle position which may enable the vehicle to determine whether it is at a known location, such as home or workplace. Moreover, GNSS module 22 can provide this location data to wireless communications device 30, which can then use this data to identify known locations, such as a vehicle operator's home or workplace.

Additionally, GNSS module 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GNSS module 22), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The position information can be supplied to remote facility 80 or other remote computer system, such as computer 78, for other purposes, such as fleet management and/or for use in a car sharing service. Also, new or updated map data can be downloaded to the GNSS module 22 from the remote facility 80 via a vehicle telematics unit.

Vehicle electronics 20 also includes a number of vehicle user interfaces that provide vehicle occupants with a means of providing and/or receiving information, including lights 50, pushbutton(s) 52, audio system 54, microphone 56, and visual display 58. As used herein, the term “vehicle user interface” broadly includes any suitable form of electronic device, including both hardware and software components, which is located on the vehicle and enables a vehicle user to communicate with or through a component of the vehicle. Vehicle lights 50 includes any lights on the vehicle and that may be controlled for presenting visual media content and/or for supplementing audiovisual media content provided to the vehicle from a third party content provider directly or via vehicle media content engine 90. Vehicle lights 50 can include interior lights that can be used to provide lighting to one or more areas within the vehicle cabin. These interior lights or other vehicle lights 50 can be light emitting diodes that are controllable by another VSM, such as an infotainment unit included in the vehicle, and may be operable to transmit light of varying colors and intensities, as well as at different times. Additionally, the vehicle lights 50 can include exterior vehicle lights, including headlights, taillights, brake lights, turn signal lights, warning lights, and/or other lights that can be used and/or are configured for use to provide aesthetic visual effects.

The pushbutton(s) 52 allow manual user input into the communications device 30 to provide other data, response, or control input. Audio system 54 provides audio output to a vehicle occupant and can be a dedicated, stand-alone system or part of the primary vehicle audio system. According to the particular embodiment shown here, audio system 54 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 56 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display and can be used to provide a multitude of input and output functions. Display 58 can be a touch screen on the instrument panel, a heads-up display reflected off of the windshield, or a projector that can project graphics for viewing by a vehicle occupant. Various other vehicle user interfaces can also be utilized, as the interfaces of FIG. 1 are only an example of one particular implementation.

With reference to FIG. 2, there is shown a method 200 of managing media content for coordinated content playback at a vehicle. Method 200 generally includes the steps of receiving content playback information that corresponds to playback of media content at a personal content playback device, obtaining media content based on the received content playback information, and sending (providing) the obtained media content to the vehicle for playback and/or presentation. However, various derivative or alternative embodiments will become apparent from the discussion below, some of which may not include these precise steps.

Method 200 begins with step 210, wherein a reservation to use a vehicle is established. The reservation can be established by vehicle backend services facility 80 in response to receiving a reservation request from a user. The reservation request can be generated by the user through use of a network device, such as a personal content playback device including a personal computer (e.g., computer 78), smartphone 14, and/or a laptop. For example, a user may use their personal device to execute a vehicle reservation application that provides a user interface whereby the user can enter information to fill the reservation request. The reservation request can then be sent by the network device to the vehicle backend services facility 80, which can then process the reservation request including authenticating the user (e.g., through verifying received user credentials as a part of the reservation request), determining a vehicle from a fleet of vehicles to fulfill the reservation, and then sending a reservation confirmation message back to the network device.

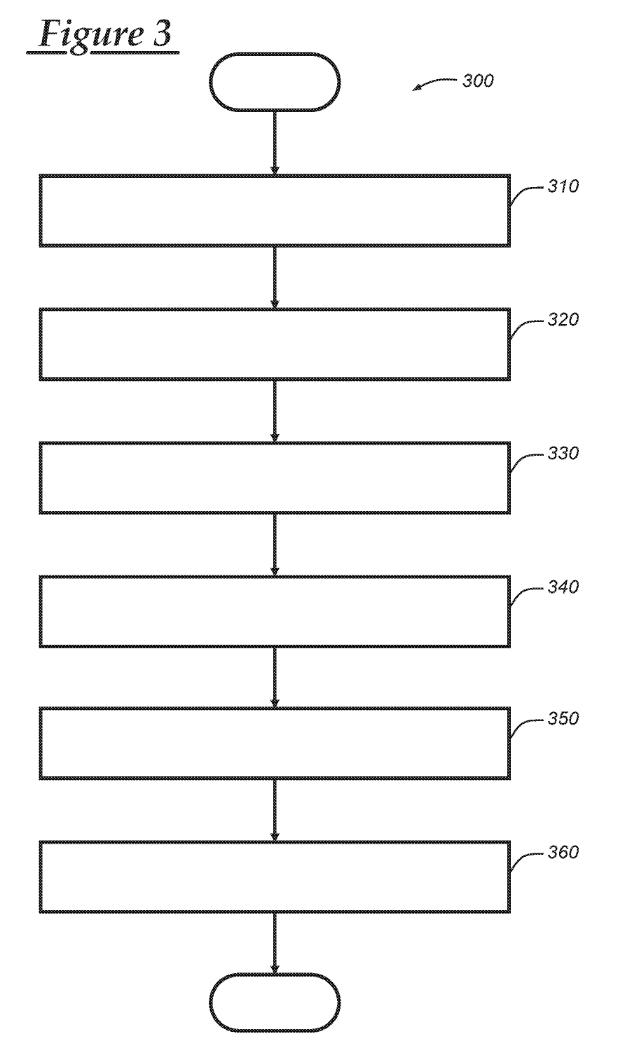

In some embodiments, the reservation request can include user credentials for use with a vehicle backend services system. The credentials can then be verified using information stored in databases 84. Additionally, the reservation request can include a reservation start time and/or a reservation end time that indicates a requested start time for the reservation and/or a requested end time for the reservation, respectively. And, at least in one embodiment, the reservation request can specify a reservation location (e.g., an address, geographical coordinates, point of interest), as well as vehicle attributes and/or other parameters that can be used to tailor the reservation to the user's desires. In other embodiments, the method 200 can be used without reservation of a vehicle; instead, a determination can be made as to when a user will use the vehicle and/or that a user is about to use the vehicle (see step 310 of method 300 (FIG. 3) for an example).

In many embodiments, when a new user is configured for using the vehicle reservation services provided by the vehicle backend services facility 80, the new user can specify one or more third party content providers that the user holds accounts with. For example, the user can indicate that they hold a subscription or account with one or more third party content providers and, additionally, the user can provide third party content provider credentials (or other subscription verification/authentication information) that can be used to access media content from the one or more third party content providers. Additionally, existing users can update their third party subscription information using the network device (e.g., smartphone 14, computer 78) or personal content playback device. This third party subscription information can be received by vehicle backend services facility 80 and then sent to vehicle media content engine 90, which can then store this third party subscription information in databases 94. In other embodiments, this third party subscription information including third party content provider credentials can be stored in databases 84. The method 200 continues to step 220.

In step 220, a reservation notification is transmitted to the personal content playback device. In one embodiment, the reservation notification can be generated by vehicle backend services servers 82 and then sent to the personal content playback device 14 via land network 76 and/or cellular carrier system 70. The reservation notification can be received at the personal content playback device 14 and may be ported to the vehicle reservation application that the user used to establish the connection. Additionally, the reservation notification can also include a content playback information request message that requests content playback information from the playback device 14. The playback device 14 can then be used to inform the user of this request and, thereafter, the user can aid the playback device 14 in fulfilling the request, which can include entering certain information, such as one or more content playback preferences. In other embodiments, the content playback information request message can be sent separately from the reservation notification. And, in some embodiments, the content playback information request message can specify a device or network to whom the content playback information should be sent, which can be, for example, one or more servers 92 at vehicle media content engine 90. For example, the content playback information request message can include an electronic address, such as an Internet Protocol (IP) address and/or a port number, which can be used to address a response to the content playback information request message.

In some embodiments, the reservation notification can be generated based on location information received from the vehicle. For example, the vehicle backend services facility 80 can be in communication with vehicle 12 and can monitor certain vehicle attributes or properties, including the vehicle's location. The vehicle's location can be determined through use of GNSS module 22 and then sent to the vehicle backend services facility 80 via cellular carrier system 70 and/or land network 76. In one embodiment, soon before the reservation start time, the vehicle backend services facility 80 can query the vehicle for the vehicle's location and, in response, the vehicle can obtain its location (e.g., through use of GNSS module 22) and then can send its location to vehicle backend services facility 80. The vehicle's location can be an address, geographical coordinates, point of interest, and/or other information that can be used to determine the vehicle's location. And, once the vehicle backend services facility 80 determines that the reservation start time is soon approaching and/or that the vehicle will be soon arriving at the reservation location, the vehicle backend services facility 80 can then generate and/or send the reservation notification to the user. The method 200 continues to step 230.

In step 230, content playback information is received. At least in one embodiment, the content playback information can be received at a server 82 of vehicle backend services facility 80. Content playback information can include a source of media content (e.g., a third party content provider identifier or name), title of media content, playback position of media content, volume of media content, closed captioning settings of media playback, language settings for media playback, and various other preferences and/or attributes of the media content playback. The content playback information can include user preferences, as well as information pertaining to recent or present media content playback at the personal content playback device 14. In one embodiment, the content playback information includes an identifier of a third party media content provider that is providing media content or had recently provided media content to the personal content playback device 14 of the user.

In addition to providing the content playback information, the vehicle can provide third party content provider credentials to the vehicle backend services facility. These third party content provider credentials can then be sent to the vehicle media content engine 90 or, in other embodiments, the third party content provider credentials can be directly sent from the personal playback device 14 to the vehicle media content engine 90. And, in a particular embodiment, the vehicle media content engine 90 can use content playback information (e.g., a third party content provider identifier) to then query a third party content provider server for additional content playback information. In some embodiments, this content playback information request message can be included in a media content request that is sent to the third party content provider, as discussed below in step 240.

In one embodiment, a user can select and/or specify an immersive media experience that can be carried out at the vehicle using media content that is received from, for example, a third party content provider. The immersive media experience can include various user preferences and/or themes that can be used to enhance the presentation of the media content at the vehicle. In one embodiment, the media content can be music or a live stream video of a dance club. In such a case, a user may select an immersive media experience that includes synchronizing vehicle lights 50 to the audio of the music or the dance club, as well as synchronizing visual effects of the dance club at with vehicle-user interfaces, such as lights 50. The selected immersive media experience can include media content playback preferences (e.g., media volume, light synchronization features, selected vehicle-user interfaces for presenting media content). These media content playback preferences can be selected by the user at the time of vehicle reservation (reservation start time), at time of establishing or requesting the vehicle reservation, and/or can be set as default preferences at any time prior to step 230. The method 200 continues to step 240.

In step 240, a media content request can be sent to the vehicle media content engine. In one embodiment, the media content request can be generated and sent by the vehicle backend services facility 80, and can include at least some of the information included in the received content playback information. For example, the media content request can include the identifier of a third party media content provider, or may include third party content provider credentials. In the case of sending the identifier of a third party media content provider, the identifier can be used to query databases 94 to obtain the third party content provider credentials. And, additionally, the media content request can include vehicle-user interface information, which is information concerning the vehicle-user interfaces output capabilities including media content playback capabilities of the various vehicle-user interfaces. For example, the vehicle can specify a screen resolution, a minimum or maximum audio or visual playback sampling rate, three-dimensional capabilities, and/or various other information pertaining to the vehicle that can be used for obtaining media content in a suitable form for playback at the vehicle-user interfaces.

In other embodiments, the personal content playback device 14 can generate and send the media content request to the vehicle media content engine 90 and, in such an embodiment, the media content request can include a vehicle identifier or electronic address so that the engine 90 can resolve where to send media content that is to be obtained pursuant to satisfying the request. And, in some embodiments, the media content request can include a content playback information request message that requests certain content playback information, such as playback position and/or playback preferences, from the third party content provider. The method 200 continues to step 250.

In step 250, media content is obtained based on the media content request. The media content can be obtained at the vehicle media content engine 90. In other embodiments, the media content can be obtained at the vehicle backend services facility 80 and/or the vehicle 12. And, according to many embodiments, the media content may be third party media content that is obtained from a third party media content provider. For example, after receiving the media content request, the vehicle media content engine 90 can use servers 92 to send a third party media content request to a third party media content provider via land network 76 and/or cellular carrier system 70. The third party media content request can include third party media content provider credentials that were previously received from the user (e.g., see steps 210 and/or 230), as well as media content identification information, such as information that can be used to determine particular media content requested.

In one embodiment, the media content request can include an identifier of the third party media content provider (as well as an identifier of the user) and, based on this information, the vehicle media content engine 90 can query databases 94 for third party media content provider credentials that correspond to the user and the third party content provider. In other embodiments, the media content request can include an electronic network address of the personal content playback device and, using this electronic address, the vehicle media content services can query personal content playback device 14 for content playback information, as well as third party media content provider credentials for the user. The method 200 continues to step 260.

In step 260, the obtained media content is processed for presentation at the vehicle. In one embodiment, the media content is obtained by the vehicle media content engine 90 and, thereafter, the obtained media content can be processed according to the vehicle-user interface information. For example, the media content may include video output that can be resized by the engine 90 according to a screen resolution size of display 58 of vehicle 12, which can be indicated in the vehicle-user interface information.

However, in other embodiments, the obtained media content can be forwarded to the vehicle for presentation without processing the obtained media content (step 270). And, as mentioned above, in some embodiments, the media content can be sent directly from a third party content provider server to the vehicle via land network 76 and cellular carrier system 70. The method 200 continues to step 270.

In step 270, the media content is sent to the vehicle for presentation. In many embodiments, the media content can be sent to the vehicle via land network 76 and/or cellular carrier system 70. For example, vehicle media content engine 90 can use a server 92 to send the media content to the wireless communications device 30 of vehicle 12. Once the media content is received, the vehicle 12 can store the media content for later playback and/or can play the media content using one or more vehicle-user interfaces, such as display 58. In some embodiments, the vehicle 12 can supplement the received media content with other audiovisual effects, such as through controlling lights or LEDs 50 on and/or within the vehicle. The lights can be controlled such that they are synchronized with the audio such that the intensity of the light being emitted reflects the intensity of the audio content playback. Other audio-synchronizing and/or supplemental lighting effects can be used.

In one embodiment, the lights and/or other effects can be presented using a vehicle-user interface that is visible to the user. For example, the vehicle can use a plurality of directional sensors to determine a location of the user's personal mobile device, such as personal content playback device 14 (e.g., smartphone 14), and, when it is determined that the user is outside the vehicle, the vehicle can send output to vehicle-user interfaces that are located on the exterior of the vehicle and/or that are perceivable by a user outside the vehicle. In one scenario, the vehicle can control a plurality of LEDs that are located on the outside of the vehicle when the user is determined to be outside the vehicle. And, thereafter, as the user enters the vehicle, the vehicle can transition the output to vehicle-user interfaces that are perceivable from within the vehicle and/or from a particular position within the vehicle, such as from a particular seat within the vehicle, which can be determined using various vehicle seat occupancy detectors or methods.

In some embodiments, a prompt can be presented to the user that queries whether the user would like to continue the media content playback at the vehicle. The prompt can be generated by the vehicle media content engine 90, vehicle backend services facility 80, vehicle 12, the personal content playback device 14, and/or another personal mobile device of the user. The user can then select to play the media content, select different media content from the same or a different media content provider, and/or select to not play media content at the vehicle. After the user selects to play media content at the vehicle, the vehicle can then use vehicle-user interfaces to present the media content to the user, as well as presenting supplemental output at the vehicle using vehicle-user interfaces. And, in some embodiments, the user may specify media content playback settings that indicate whether the user should be prompted before playback (i.e., playing the media content automatically without prompting the user) and/or other default settings that can inform the vehicle of what steps to automatically take without user input. The method 200 then ends.

With reference to FIG. 3, there is shown a method 300 of managing media content for coordinated content playback at a vehicle. Method 300 generally includes the steps of receiving a vehicle playback indication, obtaining content playback information, obtaining media content based at least partly on the obtained content playback information, and presenting the obtained media content at the vehicle. However, various derivative or alternative embodiments will become apparent from the discussion below, some of which may not include these precise steps.

Method 300 begins with step 310, wherein a vehicle playback indication is received. The vehicle playback indication indicates that media content may soon be downloaded for playback at the vehicle. In one embodiment, this vehicle playback indication may be an indication that a reservation of the vehicle may soon begin. For example, a reservation of the vehicle may have been established and, during and/or after the establishment of the reservation, the vehicle may receive an indication of the reservation start time. Thus, when the reservation start time is near, the vehicle may determine that a user will soon be arriving at the vehicle pursuant to the reservation and, also, the user may desire to continue playback of media content at the vehicle. In another embodiment, the vehicle may periodically send out advertisement messages using SRWC circuit 32 of wireless communications device 30 and, in response to the advertisement message, the personal content playback device 14 can respond indicating, for example, a desire to establish a connection. In other embodiments, the personal content playback device may send out advertisement to which the vehicle can respond.

In yet another embodiment, it can be determined that media content is or previously was being presented at the personal content playback device and that a user may desire to continue playback of the media content at the vehicle. This can include receiving an indication that media content is and/or previously was being sent or downloaded by the personal content playback device. These determinations and/or indication can be obtained by the vehicle backend services facility 80, personal content playback device 14, and/or vehicle media content engine 90. Such determinations and/or indications can then be forwarded to the vehicle 12. Or, the vehicle 12 can make these determinations based on other information received by the vehicle 12 using one or more VSMs 42, including wireless communications device 30. The method 300 then continues to step 320.

In step 320, a connection is established between the vehicle and the personal content playback device. In one embodiment, the connection can be established after the vehicle playback indication is received and/or in response to receiving the vehicle playback indication. And, in other embodiments, the vehicle 12 and/or personal content playback device can initiate a connection establishment process in response to determining that the reservation start time is near and/or to determining that a particular personal content playback device is within short-range wireless communication (SRWC) range of the wireless communications device 30. The connection can be established using a variety of different transmission/connection protocols, including SRWC such as Bluetooth™ Bluetooth™ Low Energy (BLE), and Wi-Fi™. In the case of establishing a SRWC connection, a four-way handshake and/or other shared key mechanisms can be used to establish an encryption scheme and/or keys between the wireless communications device 30 and the personal content playback device 14. In other embodiments, a wired connection can be used, such as by connecting a Universal Serial Bus (USB) cable between a USB port in the vehicle and a USB port in the personal content playback device. The method 300 then continues to step 330.

In step 330, content playback information is obtained by the vehicle. In other embodiments, such as those discussed above with respect to method 200 of FIG. 2, the content playback information can be obtained by the vehicle backend services facility 80 and/or the vehicle media content engine 90. Third party content provider credentials and/or a third party content provider identifier can, in some embodiments, accompany the content playback information that is obtained by the vehicle. Any of this information can be received at the vehicle from the personal content playback device 14 via the established connection (step 320) either in a single message or in multiple messages. Once this information is received, the method 300 continues to step 340.

In step 340, a media content request is sent. The media content request is a request to receive media content. The media content request can be sent from the vehicle to the vehicle media content engine 90 directly and/or via the backend services facility 80. Once the vehicle media content engine 90 receives this request, the vehicle media content can then forward the media content request or a part thereof to a third party content provider through use of server 92. For example, the media content request can include some content playback information or other information received from the personal content playback device, such as the third party content provider identifier. The vehicle media content engine 90 can then query databases 94 for third party content provider credentials for the third party content provider identified in the media content request. The third party content provider credentials obtained from the databases 94 can be associated with a particular user, such as the user that reserved vehicle 12, and/or can be associated with an original equipment manufacturer (OEM) or other entity that provides backend vehicle services. The vehicle media content engine can then generate a second media content request, which can include or be based on some or all of the content playback information and/or other information received from the personal content playback device 14 and/or vehicle backend services facility 80. The vehicle media content engine 90 can specify an electronic address of the vehicle to which the media content should be sent by the third party content provider. In other embodiments, the vehicle media content engine 90 can receive the media content and then send the media content to the vehicle 12.

In another embodiment, the media content request can be sent from the vehicle 12 directly to a third party content provider. In such a case, the media content request can include third party content provider credentials that are associated with the user. In one embodiment, the vehicle can query a remote database, such as databases 84 and/or 94, to determine whether the user holds a subscription with a particular third party media content provider, such as the third party media content provider specified in the information received from the personal content playback device 14 (step 330). Once the vehicle determines that the user holds the proper subscription and/or is otherwise authorized to receive media content from the particular third party media content provider, the vehicle can generate the media content request using third party media content provider credentials associated with the user and/or an entity providing vehicle backend services including the OEM of the vehicle 12. The media content request can also include a title or identifier of particular media content and/or can include certain parameters regarding the form in which the media content will be provided, such as a desired screen resolution, a particular audio output configuration (e.g., 5.1 surround sound, mono-channel), and/or various other information including any of the vehicle-user interface information discussed above. The method 300 then continues to step 350.

In step 350, media content is received from a third party media content provider. This content can be received at the vehicle and stored for later playback. Or, the media content can be streamed to a vehicle-user interface at the time of receiving the media content. Additionally, as mentioned above, the received media content can be tailored by vehicle media content engine 90 for playback at the vehicle and, in some embodiments, this tailoring can be at least partly based on vehicle-user interface information received from the vehicle 12 and/or from the vehicle backend services facility 80. The method 300 then continues to step 360.

In step 360, the media content is presented at the vehicle. The media content can include audiovisual content that is presented using display 58, audio system 54, and/or various other vehicle-user interfaces. The vehicle may also include interior lights 50 (e.g., LEDs) that can be used to provide visual effects that correspond to the audio and/or video. Other presentation features can be used as well, including any of those discussed above. The method 300 then ends.

In one embodiment, the method 200, the method 300, or parts thereof can be implemented in a computer program (or “application”) embodied in a computer readable medium and including instructions usable by one or more processors of one or more computers of one or more systems. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media (such as memory located at vehicle backend services facility 80, memory located at vehicle media content engine 90, and/or vehicle 12), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of managing media content for coordinated content playback at a vehicle, the method comprising:
receiving a vehicle playback indication, wherein the vehicle playback indication indicates that media content is or recently was being presented on a personal content playback device;
receiving media content playback information concerning playback of the media content to be carried out at the vehicle and/or playback of the media content at the personal content playback device;
obtaining media content based on the media content playback information; and
sending the media content to the vehicle, wherein the vehicle is configured to present the media content at the vehicle using one or more vehicle-user interfaces that are installed in the vehicle.

2. The method of claim 1, wherein the vehicle playback indication further includes receiving an indication that a vehicle reservation is to begin, wherein the vehicle reservation is a reservation for the user to use or ride along in the vehicle.

3. The method of claim 1, further comprising the step of sending a media content request to a third party content provider and, in response to the media content request, obtaining the media content.

4. The method of claim 3, wherein the media content playback information includes a third party content provider identifier that identifies a third party content provider that is or recently was providing the media content to the personal content playback device.

5. The method of claim 4, wherein the third party content provider credentials are used to query a database for third party content provider credentials, and wherein the media content request includes the third party content provider credentials.

6. The method of claim 1, further comprising sending a first media content request from a vehicle backend services facility to a vehicle media content engine, wherein the first media content request includes at least some of the media content playback information.

7. The method of claim 6, further comprising the step of processing the media content using the vehicle media content engine based on vehicle-user interface information concerning one or more vehicle-user interfaces at the vehicle that are configured to provide audio and/or visual output and, thereafter, sending the processed media content to the vehicle.

8. The method of claim 7, further comprising the step of sending a second media content request to a third party content provider, wherein the second media content request is at least partly based on information received in the first media content request.

9. The method of claim 8, wherein the second media content request includes or is accompanied by vehicle addressing and/or identification information, wherein the media content is sent from the vehicle media content engine to the vehicle based at least partly on the vehicle addressing and/or identification information.

10. The method of claim 1, wherein the personal content playback device is a smartphone, smart television, laptop, tablet, or personal computer.

11. A method of managing media content for coordinated content playback at a vehicle, the method comprising:
receiving an indication of a vehicle reservation at a vehicle backend services facility, wherein the vehicle reservation includes a reservation start time and a reservation start location;
receiving media content playback information from a personal content playback device of a user;
sending a first media content request to a vehicle media content engine, wherein the first media content request includes vehicle addressing and/or identification information, wherein the media content is sent to the vehicle based at least partly on the vehicle addressing and/or identification information; and sending a second media content request to a third party content provider, wherein the second media content request includes at least some of the information contained in the first media content request.

12. The method of claim 11, further comprising the steps of receiving the media content from the third party content provider in response to the second media content request and sending the received media content to the vehicle based on the vehicle addressing and/or identification information.

13. The method of claim 12, further comprising the step of processing the received media content before sending the received media content to the vehicle, wherein the processing includes configuring the media content for playback at one or more vehicle-user interfaces included in the vehicle, and wherein the processing is based on vehicle-user interface information concerning one or more vehicle-user interfaces at the vehicle that are configured to provide audio and/or visual output.

14. The method of claim 13, wherein the media content is processed based on a selected immersive media experience, and wherein the selected immersive media experience includes media content playback preferences.

15. The method of claim 14, wherein at least some of the media content playback preferences of the selected immersive media experience are selected or set by the user of the personal content playback device.

16. The method of claim 11, wherein the second media content request includes the vehicle addressing and/or identification information such that the media content can be directly delivered from the third party content provider to the vehicle.

17. The method of claim 11, wherein the vehicle is configured to receive the media content and to present the media content using one or more vehicle-user interfaces included in the vehicle.

18. A vehicle backend system, comprising:
a vehicle backend services facility that includes a plurality of vehicle backend services servers and a plurality of vehicle backend services databases, wherein at least some of the plurality of vehicle backend services servers includes a processing device that is configured to execute a vehicle backend services computer program;
a vehicle media content engine that includes a plurality of vehicle media content engine servers and a plurality of vehicle media content engine databases, wherein at least some of the plurality of vehicle media content engine servers includes a processing device that is configured to execute a vehicle media content engine computer program;
wherein the processing devices of the at least some vehicle backend services servers, when executing the vehicle backend services computer program, causes the vehicle backend services system to:
receive an indication of a vehicle reservation at the vehicle backend services facility, wherein the vehicle reservation includes a reservation start time and a reservation start location;
receive media content playback information from a personal content playback device of a user;
send a first media content request to the vehicle media content engine, wherein the first media content request includes vehicle addressing and/or identification information, wherein the media content is sent to the vehicle based at least partly on the vehicle addressing and/or identification information; and
wherein the processing devices of the at least some vehicle media content engine servers, when executing the vehicle media content engine computer program, causes the vehicle backend services system to:
receive the first media content request from the vehicle backend services facility; and
send a second media content request to a third party content provider, wherein the second media content request includes at least some of the information contained in the first media content request.

19. The system of claim 18, wherein the processing devices of the at least some vehicle media content engine servers, when executing the vehicle media content engine computer program, further causes the vehicle backend services system to receive the media content from the third party content provider and to send the media content to the vehicle.

20. The method of claim 19, wherein the processing devices of the at least some vehicle media content engine servers, when executing the vehicle media content engine computer program, further causes the vehicle backend services system to process the received media content before sending the media content to the vehicle.
